(19) United States
(12) Patent Application Publication
(10) Pub. No.: US 2010/0295690 A1
(43) Pub. Date: Nov. 25, 2010

(54) DISHWASHER HAVING A TURBIDITY SENSOR

(75) Inventors: Erik Berends, Bielefeld (DE); Guenther Ennen, Enger (DE); Seyfettin Kara, Spenge (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: MIELE & CIE. KG, Guetersloh (DE)

(21) Appl. No.: 12/740,135

(22) PCT Filed: Oct. 29, 2008
(86) PCT No.: PCT/EP08/09103

§ 371 Date: Aug. 6, 2010

(30) Foreign Application Priority Data
Oct. 31, 2007 (DE) 10 2007 052 332.9

(51) Int. Cl. G08B 21/00

(52) U.S. Cl. 340/604

(57) ABSTRACT

The invention relates to a dishwasher comprising a control and display unit having input elements (1, 3, 4, 5, 6, 7, 8) for the selection of a washing program from a plurality of possible programs, at least one display means (2), means for controlling the program parameters, such as the duration and temperature profile of individual program segments, and a turbidity sensor, by means of which a degree of contamination of a rinsing liquor can be detected. According to the invention, the degree of contamination detected by the turbidity sensor is displayed on the display means (2), at least intermittently, thus simplifying operation.

The present invention relates to a dishwasher including a user control and display unit having input elements for the selection of a wash cycle from a plurality of possible wash cycles, at least one display means, means for controlling cycle parameters, such as the duration and temperature profile of individual sub-cycles, and further having a turbidity sensor capable of measuring the soil level of a wash liquid.

German Patent DE 100 59 112 C1 describes a dishwasher having a turbidity sensor provided in a wash-water circuit to measure the soil level of the wash liquid. Automatic wash cycles can then be performed as selected or modified according to the detected signals, for example, to add additional intermediate rinse cycles, thus making it possible to optimize the dishwashing sequence. The choice of wash cycles also includes fixedly predetermined, standard wash cycles, during which the values measured by the turbidity sensor are not evaluated. A dishwasher of this type is problematic in that it does not provide the user with any feedback that would allow him or her to make a better choice the next time he or she selects a wash cycle. If the user constantly chooses a wash cycle that is inadequate for the existing soil load, resources may be unnecessarily wasted.

It is, therefore, an object of the present invention to provide a dishwasher that offers a high degree of ease of operation.

This object is achieved by a dishwasher having the features of claim 1. Advantageous embodiments and refinements of the present invention will become apparent from the following dependent claims.

In accordance to the present invention, the soil level detected by the turbidity sensor is displayed, at least temporarily, on the display means, so that the user is provided with feedback on whether the wash cycle selected was appropriate for the soil level actually present. The user is thereby enabled to select an optimum dishwashing sequence, and is easily guided through the process of entering control information.

In accordance with a preferred embodiment of the present invention, the soil level is displayed directly in several gradations. In this manner, the user can be provided with feedback on how the soil level is assessed by the controller of the dishwasher. The user can then select the desired wash cycle himself or herself, at least the next time he or she turns on the dishwasher. Alternatively, the soil level may also be displayed in the form of information on the selection of a suitable wash cycle, since what is primarily important to the user is that a suitable wash cycle is selected, and that he or she then has to deal only indirectly with the soil load of the dishes. For these purposes, the detected soil level can be used to automatically select the wash cycle, this selection then being displayed.

In accordance with another embodiment of the present invention, a soil level can be selected using the input elements, and a comparison can be made by the controller as to whether the actual soil level substantially corresponds to the soil level selected by the user. If the actual soil level differs from the soil level that has been selected, correction information may be output, providing instructions to the user. Alternatively, such correction information may be displayed only after a deviation between the actual soil level and the selected soil level has been detected several times, so that corresponding instructions are issued to the user only after he or she has repeatedly made incorrect selections.

If the actual soil level differs from the soil level that has been selected, at least one sub-cycle of a wash cycle may be automatically modified by the controller independently of the display of information. Such modification may be, for example, to add an additional rinse cycle to deal with coarse soils more effectively. It is also possible to vary other parameters, such as temperature and duration of the dishwashing sequence.

The present invention will be explained in more detail below with reference to an exemplary embodiment and the accompanying drawings, in which:

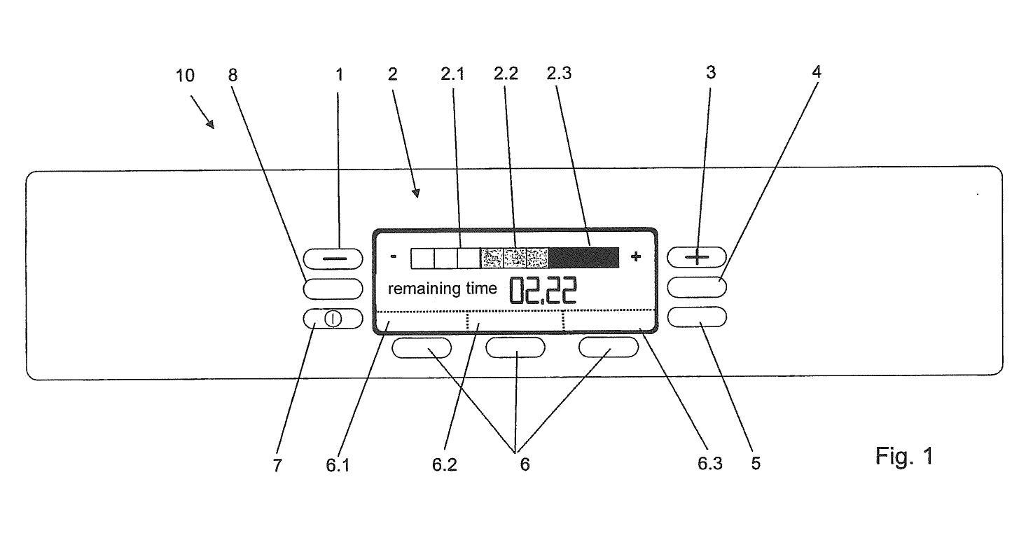

FIG. 1 is a view of a control panel for a dishwasher according to the present invention;

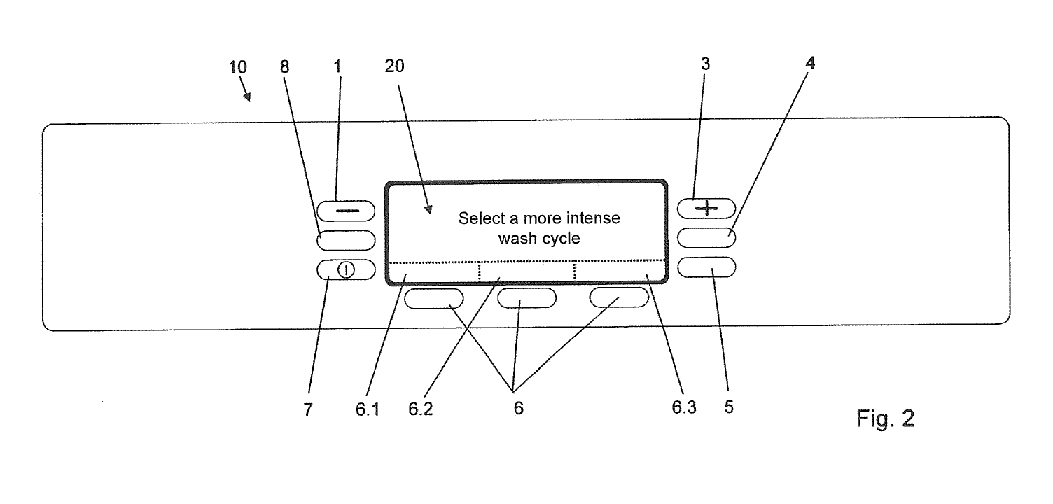

FIG. 2 is a view showing the control panel of FIG. 1 as it displays correction information.

FIG. 1 shows a control panel 10 of a dishwasher (not shown). The control panel includes display means 2, preferably in the form of an LC display having different fields 2.1, 2.2 and 2.3 for displaying a selected soil level. The soil level can be selected using a minus button 1 and a plus button 3. Control panel 10 further contains a button 4 having a delay start function and a button 5 for starting the selected wash cycle. On the other side of display 2, there is provided a button 7 for activating and deactivating the dishwasher, and a button 8 which can be used to switch the display from the display mode to a textual display mode [sic], in which additional information is displayed to the user.

Located underneath display 2 are three buttons 6 which allow selection of further cycle options for the selected wash cycle. Using these buttons 6, it is possible to select cycle options that affect, for example, energy consumption, noise emission, wash cycle duration, temperature, etc. Buttons 6 each have one display field 6.1, 6.2 or 6.3 associated therewith, so that the corresponding cycle options are presented to the user on display 2.

The dishwasher is further equipped with a turbidity sensor for measuring the soil level actually present. This sensor may be designed as described in German Patent DE 100 59 112 C1.

To operate the dishwasher, the user may select a predetermined soil level using buttons 1 and 3 accordingly. Moreover, buttons 6 allow selection of additional cycle options.

During the execution of the wash cycle, the turbidity sensor detects whether the selected soil level corresponds approximately to the soil level actually present. If this is the case, the wash cycle continues in the selected manner. However, if deviations exist, the controller may directly influence the selection of the wash cycle and modify the same, for example, by adding an additional rinse step, increasing the temperature, increasing the wash cycle duration, changing spray pressure, etc. in order to adapt the dishwashing sequence to optimally match the soil level actually present.

If during the wash cycle, a deviation is detected between the selected soil level and the actual soil level, the controller may display correction information, as is illustrated in FIG. 2. Display 2 displays correction information 20: “Select a more intense wash cycle!” This information may be displayed either during the execution of the wash cycle, so that only the user may influence the wash cycle or, alternatively, the information may be displayed upon completion of the wash cycle to enable the user to make a better selection next time. It is also possible to display correction information 20 only after the user has repeatedly made incorrect selections, thereby preventing the user from being informed of selection errors that result from a single mistake.

In the exemplary embodiment shown, the soil level can be selected directly during control of the dishwasher. However, the present invention can also be used in control systems, where it is only possible to select a wash cycle, but not to select a soil level.

1.-8. (canceled)

9. A dishwasher comprising:
an input element configured to select a first wash cycle from a plurality of wash cycles;
a controller configured to control a cycle parameter;
a turbidity sensor configured to measure a soil level of a wash liquid; and
a display device configured to at least temporarily display the soil level measured by the turbidity sensor.

10. The dishwasher as recited in claim 9, wherein the display device is configured to display the soil level in a plurality of gradations.

11. The dishwasher as recited in claim 9, wherein the display device is configured to display the soil level in a form of information on a selection of a suitable wash cycle of the plurality of wash cycles.

12. The dishwasher as recited claim 9, wherein the display device is configured to display an automatically selected wash cycle of the plurality of wash cycles, the automatically selected wash cycle being based on the measured soil level.

13. The dishwasher as recited claim 9, wherein the input element is configured to select a soil level, and wherein the controller is configured to perform a comparison as to whether an actual soil level substantially corresponds to the selected soil level.

14. The dishwasher as recited in claim 13, wherein if the actual soil level differs from the selected soil level, correction information is output.

15. The dishwasher as recited in claim 14, wherein the display device is configured to display the correction information after a deviation between the actual soil level and the selected soil level has been detected a plurality of times.

16. The dishwasher as recited in claim 9, wherein the input element is configured to select a soil level, and wherein the controller is configured to automatically modify at least one sub-cycle of the first wash cycle when an actual soil level differs from the selected soil level.

17. The dishwasher as recited in claim 1, wherein the cycle parameter includes at least one of a duration and temperature profile of a sub-cycle.
